(19) United States
(12) Patent Application Publication
(10) Pub. No.: US 2012/0254639 A1
(43) Pub. Date: Oct. 4, 2012

(54) COMMUNICATION APPARATUS, POWER CONTROL METHOD THEREOF, AND COMPUTER READABLE MEDIUM

(76) Inventors: Koichi Masuda, Higashimurayama-shi (JP); Takeshi Horiuchi, Hachioji-shi (JP); Tomozo Murayama, Hachioji-shi (JP)

(21) Appl. No.: 13/333,820

(22) Filed: Dec. 21, 2011

(30) Foreign Application Priority Data
Mar. 29, 2011 (JP) 2011-073247

(51) Int. Cl. G06F 1/26

(52) U.S. Cl. 713/310

(57) ABSTRACT

According to one embodiment, a communication apparatus includes a processor, a detector, and a controller. The processor operates by a power class selectively set from a plurality of power classes including different maximum power supply amounts in accordance with a connected power sourcing equipment, and executes a communication process. The detector detects a count of an authentication process executed between the communication apparatus and the power sourcing equipment when the communication apparatus is connected to the power sourcing equipment. The controller sets in the processor a power class corresponding to the connected power sourcing equipment, based on a detection result obtained by the detector.

### CROSS-REFERENCE TO RELATED APPLICATIONS

This application is based upon and claims the benefit of priority from prior Japanese Patent Application No. 2011-073247, filed Mar. 29, 2011, the entire contents of which are incorporated herein by reference.

### FIELD

Embodiments described herein relate generally to a communication apparatus to be used as, e.g., an IP (Internet Protocol) telephone, and a power control method thereof, and a computer readable medium.

### BACKGROUND

Recently, an IP telephone system in which images and sounds are bidirectionally transmitted and received as packet data in real time across an IP (Internet Protocol) network is widespread. In this IP telephone system, it is possible to perform audio communication not only between IP telephone terminals connected to the IP network but also between an IP telephone terminal and a telephone terminal connected to a public network. This audio communication can be achieved by supplying power (driving electric power) from a LAN power sourcing equipment such as a router or switching hub constructing a LAN (Local Area Network), in accordance with a power supply method such as POE (Power Over Ether®). This IP telephone terminal complies with, e.g., the IEEE802.3af standards.

On the other hand, in the above-mentioned IP telephone system, IP telephone terminals connected to the IP network can also perform video communication by using moving images. This video communication is performed using an IP telephone terminal complying with the IEEE802.3at standards whose maximum power consumption is higher than that of the IEEE802.3af standards.

The IEEE802.3af standards and IEEE802.3at standards described above are compatible; a powered device (to be referred to as a PD hereinafter) complying with the IEEE802.3at standards can also receive power from a LAN power sourcing equipment (to be referred to as a PSE hereinafter) complying with only the IEEE802.3af standards. However, a PD complying with the IEEE802.3at standards must be set to class 4, but is recognized as a class-0 PD when connected to a PSE complying with only the IEEE802.3af standards.

Accordingly, all communication apparatuses complying with the IEEE802.3at standards are handled as class 0 when connected to a PSE complying with only the IEEE802.3af standards. Consequently, the PSE cannot efficiently perform power supply management in accordance with classes.

Also, when manually setting classes in accordance with the standards with which the PSE complies, the operation is cumbersome, and an error such as a setting error may occur.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the configuration of an IP telephone system according to the first embodiment;

FIG. 2 is a block diagram showing the arrangement of an IP telephone terminal as a communication apparatus shown in FIG. 1;

FIG. 3 is a block diagram showing the functional configuration of a main controller shown in FIG. 2;

FIG. 4 is an activation sequence timing chart when the IP telephone terminal according to the first embodiment is connected to a hub;

FIG. 5 is a view showing a sequence when performing audio communication by connecting the IP telephone terminal according to the first embodiment to a hub complying with the IEEE802.3af;

FIG. 6 is a view showing a sequence when performing video communication by connecting the IP telephone terminal according to the first embodiment to a hub complying with the IEEE802.3at;

FIG. 7 is a block diagram showing the functional configuration of a main controller according to the second embodiment; and

FIG. 8 is a flowchart showing the procedure of a control process performed by a controller according to the second embodiment.

### DETAILED DESCRIPTION

Various embodiments will be described hereinafter with reference to the accompanying drawings. In general, according to one embodiment, a communication apparatus includes a processor, a detector, and a controller. The processor operates by a power class selectively set from a plurality of power classes including different maximum power supply amounts in accordance with a connected power sourcing equipment, and executes a communication process. The detector detects a count of an authentication process executed between the communication apparatus and the power sourcing equipment when the communication apparatus is connected to the power sourcing equipment. The controller sets in the processor a power class corresponding to the connected power sourcing equipment, based on a detection result obtained by the detector.

### First Embodiment

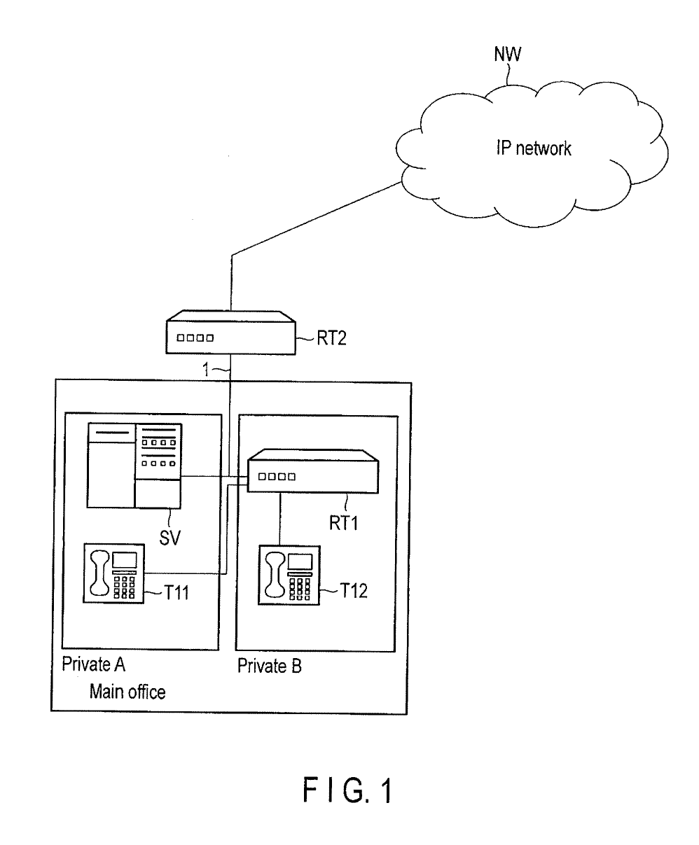

FIG. 1 is an exemplary view showing the configuration of an IP telephone system according to the first embodiment.

This system includes a LAN (Local Area Network) 1 in a main office or the like. The LAN 1 is connected to a call control server SV, and a hub RT1 and router RT2 as power sourcing equipments. IP telephone terminals T11 and T12 as communication apparatuses are connected to the hub RT1. The hub RT1 performs authentication on the connected IP telephone terminals T11 and T12, and supplies electric power to the IP telephone terminals T11 and T12 in accordance with the authentication results.

The IP telephone terminals T11 and T12 are terminals having a speech communication processing function and media information processing function.

The router RT2 connects the LAN 1 to an IP network NW such as the Internet. The call control server SV has a switching control function of establishing a session in accordance with, e.g., an SIP, between the IP telephone terminals T11 and T12 or between the IP telephone terminal T11 or T12 and an IP telephone terminal on the IP network NW. After the session is established, audio communication is performed by a peer-to-peer connection between a telephone terminal on the outgoing side and that on the terminating side.

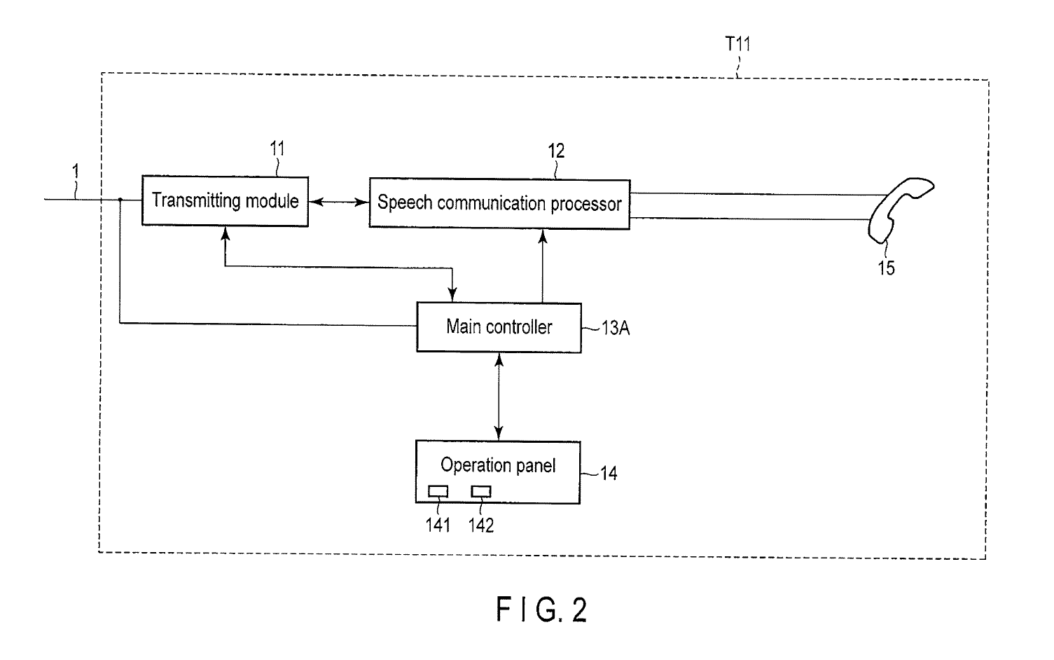

The above-mentioned IP telephone terminals T11 and T12 have the following function as a function according to the first embodiment. FIG. 2 is a block diagram showing the arrangement of the function. The explanation will be made by taking the IP telephone terminal T11 as an example.

Referring to FIG. 2, the IP telephone terminal T11 includes a transmitting module 11, speech communication processor 12, main controller 13A, operation panel 14, and handset 15. The transmitting module 11 exchanges various kinds of data with an external apparatus by transmission. Also, the transmitting module 11 extracts a speech communication signal and control signal from, e.g., an RTP packet transmitted from an external apparatus, and supplies the speech communication signal to the speech communication processor 12 and the control signal to the main controller 13A. In addition, the transmitting module 11 generates an RTP packet for transmission by time-divisionally multiplexing a serial data signal supplied from the speech communication processor 12 or main controller 13A, and transmits the RTP packet.

The speech communication processor 12 extracts speech communication data contained in the speech communication signal supplied from the transmitting module 11, and reproduces an analog received audio signal from this speech communication data. Then, the speech communication processor 12 drives the receiver of the handset 15 by the reproduced received audio signal, thereby outputting the received audio. Also, the speech communication processor 12 receives an analog transmitting audio signal generated by the transmitter of the handset 15. The speech communication processor 12 converts this transmitting audio signal into a speech communication signal having a predetermined form, and supplies the signal to the transmitting module 11.

The main controller 13A includes a CPU, ROM, and RAM, and controls each module of the IP telephone terminal T11 by software processing. Also, the main controller 13A operates by electric power supplied from the hub RT1.

The operation panel 14 includes a display module 141 such as an LCD (Liquid Crystal Display), and a key input module 142. The display module 141 displays, e.g., various kinds of information representing the operation state of the terminal, which are output from the main controller 13A, and a telephone directory.

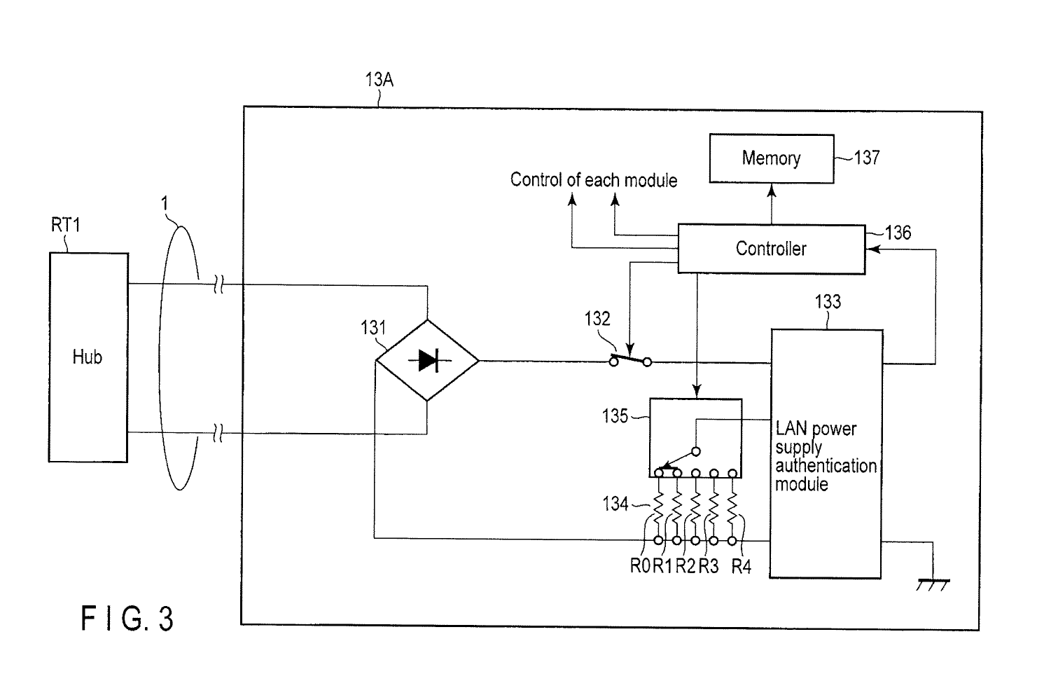

The above-mentioned main controller 13A has the following function as a function according to this embodiment. FIG. 3 is a block diagram showing the arrangement of the function.

The main controller 13A includes a diode bridge 131, a cut-off switch 132, a LAN power supply authentication module 133 (to be referred to as an authentication module 133 hereinafter), a class setting resistor 134 including a plurality of resistors R0 to R4 corresponding to different power classes, a latching relay 135, a controller 136, and a memory 137.

The diode bridge 131 supplies an electric current supplied from the hub RT1 across the LAN 1, to the authentication module 133 via the power supply path cut-off switch 132.

The authentication module 133 supplies an appropriate electric current in response to a voltage applied for powered device authentication (detection) by the hub RT1, thereby indicating to the hub RT1 that the terminal is a valid powered device. In class authentication (classification) after that, the authentication module 133 applies a specific voltage to one of the resistors R0 to R4 of the class setting resistor 134 via the latching relay 135, and supplies an electric current corresponding to each power class, thereby notifying the hub RT1 of an appropriate power class. Furthermore, the authentication module 133 detects the count of the authentication process executed between the terminal and hub RT1.

The controller 136 comprehensively controls the processes performed by the transmitting module 11, speech communication processor 12, power supply path cut-off switch 132, and latching relay 135 described above. When changing the power class based on the detection result obtained by the authentication module 133, the controller 136 controls the latching relay 135 so as to, e.g., switch the resistor R0 as a change source in the ON state to the OFF state, and switch the resistor R4 as a change destination to the ON state. The controller 136 stores a class value indicating the switched power class in the memory 137.

The operation of the above-mentioned configuration will be explained below.

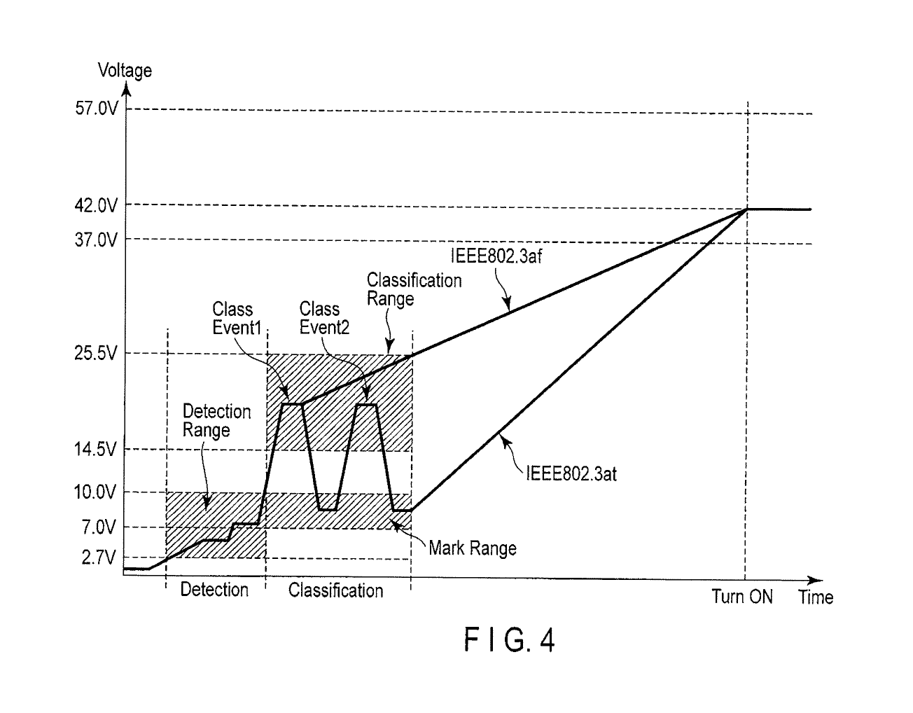

FIG. 4 is an activation sequence timing chart when, e.g., the IP telephone terminal T11 is connected to the hub RT1.

When the IP telephone terminal T11 is connected to the hub RT1 across the LAN 1, the hub RT1 performs a series procedures for starting power supply to the IP telephone terminal T11, i.e., powered device authentication (detection) and class authentication (classification).

The detection is performed by detecting the value of an electric current flowing when the hub RT1 applies a voltage pulse of, e.g., 7 [v] or more to the authentication module 133. The classification is performed by detecting the value of an electric current flowing when the hub RT1 applies a voltage pulse between, e.g., 14.5 and 20.5 [v] to the authentication module 133.

In the first embodiment, the authentication module 133 detects how many times the voltage pulse of the classification is applied (i.e., detects class events). If the count is one, the authentication module 133 determines that the hub RT1 is an apparatus complying with the conventional IEEE802.3af. If the count is two, the authentication module 133 determines that the hub RT1 is an apparatus complying with the IEEE802.3at.

If the hub RT1 complies with the IEEE802.3af, the controller 136 of the IP telephone terminal T11 performs activation and reads out, from the memory 137, a conventional class value C1 (within the range of 0 to 3) set in accordance with the maximum power consumption of the terminal. If the readout class value C1 differs from a present class value C2 stored in the memory 137, the controller 136 controls the latching relay 135 to switch the class setting resistor 134 to a corresponding one of the resistors R0 to R3. The resistance values of the resistors R0 to R3 meet the condition R0<R1<R2<R3. Also, the controller 136 performs nothing if the presently set class value C2 is the same as the optimum class value C1.

If the hub RT1 complies with the IEEE802.3at, the controller 136 of the IP telephone terminal T11 performs activation and reds out the present class value C2 stored in the memory 137. If the class value C2 differs from class 4, the controller 136 controls the latching relay 135 to switch the resistor of the class setting resistor 134 to the resistor R4 corresponding to class 4. The resistance value of the resistor R4 is larger than those of the resistors R0 to R3. Also, the controller 136 performs nothing if the presently set class value C2 is class 4.

When the constant of the class setting resistor 134 is changed, i.e., when the resistors R0 to R4 are switched, the controller 136 operates the power supply path cut-off switch 132 to stop power supply to the IP telephone terminal T11 for a predetermined time. After the elapse of the predetermined time, the controller 136 turns on the power supply path cut-off switch 132, thereby performing the authentication procedure from the hub RT1 again, and notifying the hub RT1 of the changed power class.

(Connection of IP Telephone Terminal Complying with IEEE802.3at to Power Supply Device Complying with IEEE802.3af)

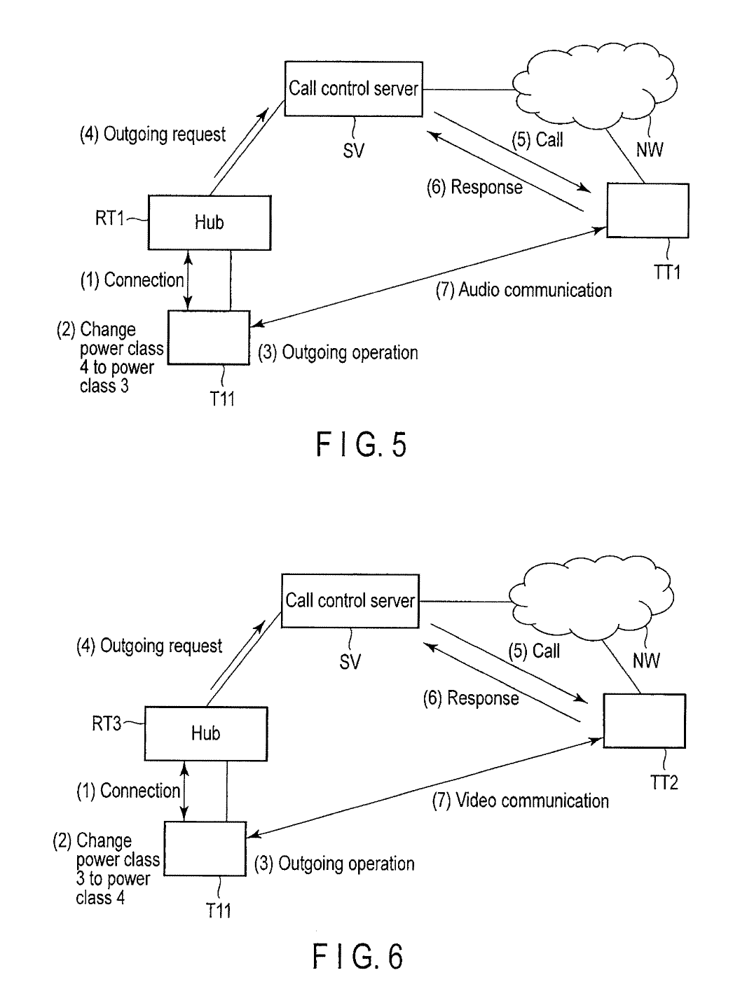

FIG. 5 is a view showing a sequence when performing audio communication by connecting the IP telephone terminal T11 to the hub RT1.

Assume that the user of the IP telephone terminal T11 complying with the IEEE802.3at connects the IP telephone terminal T11 to the hub RT1 installed in private B by using the LAN 1 because a hub installed in private A of the main office has failed ((1) in FIG. 5). Since the hub RT1 complies with the IEEE802.3af, the hub RT1 cannot recognize power class 4 and hence recognizes the IP telephone terminal T11 as an apparatus of power class 0. In this case, the hub RT1 cannot perform power distribution corresponding to the power class.

In the first embodiment, therefore, the IP telephone terminal T11 automatically discriminates an authentication method performed between the terminal and hub RT1, and switches the power classes, thereby avoiding standard mismatch with the hub RT1.

The authentication module 133 of the IP telephone terminal T11 detects how many times the voltage pulse of the classification is applied (i.e., detects class events). Since the count is one in this case, the authentication module 133 determines that the hub RT1 is an apparatus complying with the conventional IEEE802.3af.

Then, the controller 136 of the IP telephone terminal T11 performs activation and reads out, from the memory 137, a class value indicating power class 4 set in accordance with the maximum power consumption of the terminal. Since the determined class value described above differs from the present class value stored in the memory 137, the controller 136 controls the latching relay 135 to turn off the resistor R4 of the class setting resistor 134, and turn on the resistor R3 ((2) in FIG. 5). After that, the controller 136 stores a class value corresponding to power class 3 in the memory 137.

Assume that the user of the IP telephone terminal T11 belonging to private A has performed an outgoing operation to an external terminal TT1 on the IP network NW by operating the key input module 142 of the IP telephone terminal T11 ((3) in FIG. 5). In this case, the IP telephone terminal T11 transmits an outgoing request to the call control server SV ((4) in FIG. 5).

When receiving the above-mentioned outgoing request, the call control server SV transmits the outgoing request to the external terminal TT1 to cause it to perform terminating notification ((5) in FIG. 5). This terminating notification is performed by generating a sound or displaying a message indicating an incoming call. When the user performs an operation in response to this terminating notification, the external terminal TT1 transmits a connection response signal to the call control server SV ((6) in FIG. 5).

When receiving the connection response signal, the call control server SV forms a communication link between the IP telephone terminal T11 and external terminal TT1 ((7) in FIG. 5). This enables audio communication between the IP telephone terminal T11 and external terminal TT1.

(Connection of IP Telephone Terminal Complying with IEEE802.3at to Power Supply Device Complying with IEEE802.3at)

FIG. 6 is a view showing a sequence when performing video communication by connecting the IP telephone terminal T11 to a hub RT3 complying with the IEEE802.3at.

Assume that the hub RT3 installed in private A of the main office has recovered from a failure. Assume also that the user of the IP telephone terminal T11 complying with the IEEE802.3at has removed the IP telephone terminal T11 connected to the hub RT1 installed in private B, and connected the IP telephone terminal T11 to the hub RT3 ((1) in FIG. 6). In this case, video communication using moving images can be performed because electric power higher than that of the IEEE802.3af can be supplied to the IP telephone terminal T11.

The authentication module 133 of the IP telephone terminal T11 detects how many times the voltage pulse of the classification is applied (i.e., detects class events). Since the count is two in this case, the authentication module 133 determines that the hub RT3 is an apparatus complying with the IEEE802.3at.

Then, the controller 136 of the IP telephone terminal T11 performs activation and reads out, from the memory 137, the class value indicating power class 3 set in accordance with the maximum power consumption of the terminal. Since the above-mentioned determined class value differs from the present class value stored in the memory 137, the controller 136 controls the latching relay 135 to turn off the resistor R3 of the class setting resistor 134 and turn on the resistor R4 ((2) in FIG. 6). After that, the controller 136 stores the class value corresponding to power class 4 in the memory 137.

Assume that the user of the IP telephone terminal T11 belonging to private A has performed an outgoing operation designating “moving images” to an external terminal TT2 on the IP network NW by operating the key input module 142 of the IP telephone terminal T11 ((3) in FIG. 6). In this case, the IP telephone terminal T11 transmits an outgoing request to the call control server SV ((4) in FIG. 6).

When receiving the above-mentioned outgoing request, the call control server SV transmits the outgoing request to the external terminal TT2 to cause it to perform terminating notification ((5) in FIG. 6). This terminating notification is performed by generating a sound or displaying a message indicating an incoming call. When the user performs an operation in response to this terminating notification, the external terminal TT2 transmits a connection response signal to the call control server SV ((6) in FIG. 6).

When receiving the connection response signal, the call control server SV forms a communication link for video communication between the IP telephone terminal T11 and external terminal TT2 ((7) in FIG. 6). This enables video communication using “moving images” between the IP telephone terminal T11 and external terminal TT2.

In the first embodiment as described above, when connecting the IP telephone terminal T11 to the hub RT1, the authentication module 133 of the IP telephone terminal T11 detects the count of the authentication process performed between the terminal and hub RT1. Based on this detection result, the controller 136 automatically determines whether the hub RT1 as a connection destination complies with the IEEE802.3af or IEEE802.3at. In accordance with the hub RT1 complying with the IEEE802.3af, the controller 136 updates power class 4 stored in the memory 137 to power class 3, and controls the latching relay 135 so as to switch the resistor R4 in the ON state to the OFF state, and switch the resistor R3 to the ON state.

Accordingly, the IP telephone terminal T11 can always notify power class matching the standards of the hub RT1 as a power supply device, and can avoid inefficient power management caused by class authentication mismatch by which, e.g., power class 4 is recognized as power class 0. Also, since power class switching is automated, it is possible to save the trouble of setting when installing the IP telephone terminal T11, and avoid human setting errors. Furthermore, in the power class changing process, it is only necessary to switch a resistor as a change source in the ON state to the OFF state, and switch a resistor as a change destination to the ON state. This makes it possible to simply change the power class within a short time.

In addition, when performing the power class changing process in the above-mentioned first embodiment, the power supply path cut-off switch 132 for ON/OFF switching between the hub RT1 and LAN power supply authentication module 133 is switched to the OFF state for a predetermined period, and switched to the ON state after the elapse of the predetermined period, thereby performing reactivation. Consequently, the authentication procedure from the hub RT1 is performed again, and the hub RT1 can be notified of the changed power class. This makes it possible to avoid inefficient power management caused by class authentication mismatch.

Also, in the aforementioned first embodiment, when connecting the IP telephone terminal T11 to the hub RT3 complying with the IEEE802.3at, power class 3 corresponding to the hub RT1 is changed to power class 4 corresponding to the hub RT3. Therefore, it is possible to use services requiring large power supply amounts, e.g., video communication using moving images.

Furthermore, when executing the power class change control in the above-described first embodiment, the authentication module 133 can execute processes from the authentication process with respect to the hub RT1 to the power class changing process without depending on the controller 136. Accordingly, the reduction in processing can be used in, e.g., the control of the communication process by the controller 136.

### Second Embodiment

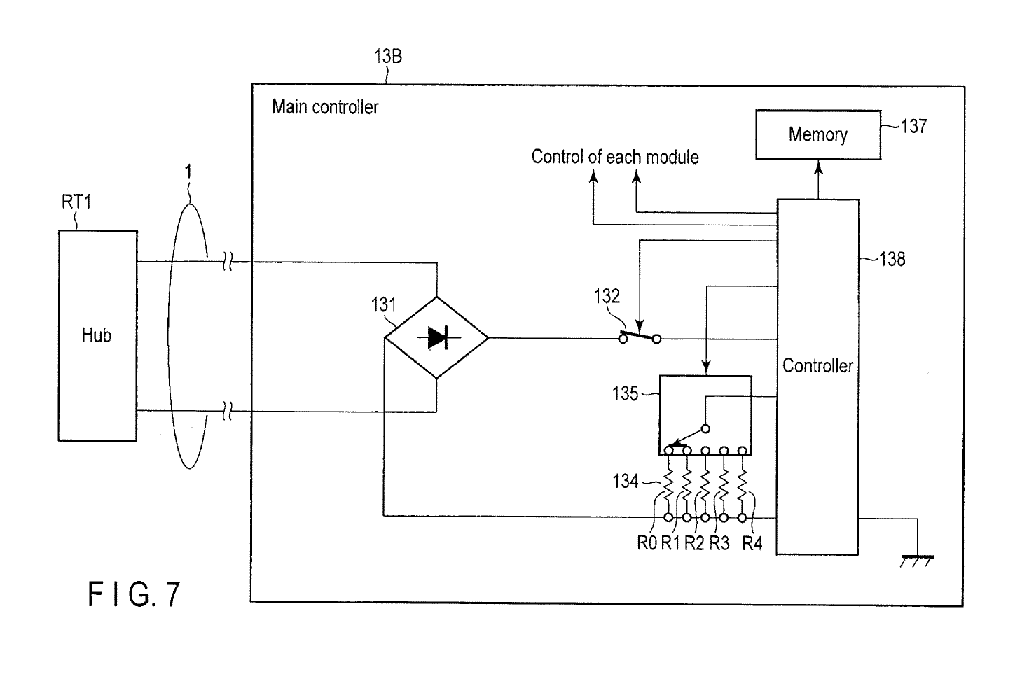

FIG. 7 is a view showing the functional configuration of a main controller 13B according to the second embodiment. Note that the same reference numerals as in FIG. 3 denote the same parts in FIG. 7, and a repetitive explanation will be omitted.

In the second embodiment, one controller 138 functions as both the authentication module 133 and controller 136 described previously.

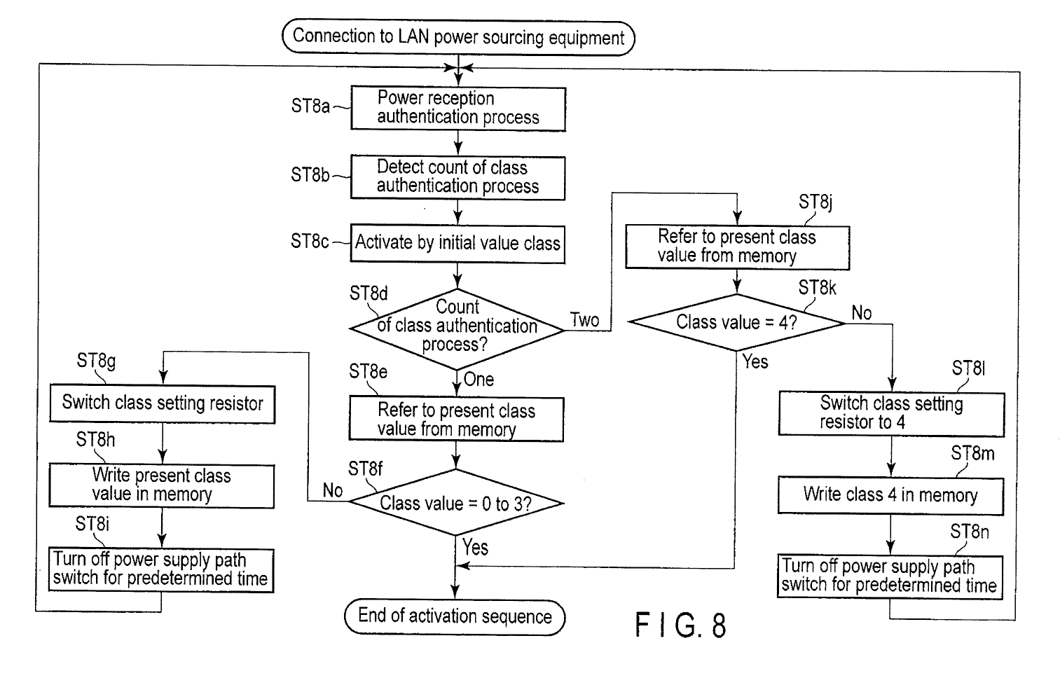

FIG. 8 is a flowchart showing the procedure of a control process performed by the controller 138.

Assume that the user of an IP telephone terminal T11 complying with the IEEE802.3at has connected the IP telephone terminal T11 to a hub RT1 installed in private B of a main office by using a LAN 1 because a hub installed in private A has failed. In this case, the hub RT1 performs powered device authentication (detection) in order to start power supply to the IP telephone terminal T11. On the other hand, the controller 138 gradually raises the voltage to 7 [v] (block ST8a).

Subsequently, the hub RT1 performs class authentication (classification) on the IP telephone terminal T11. The controller 138 detects how many times the voltage pulse of the classification is applied (i.e., detects class events) (block ST8b). Also, the controller 138 performs activation by an initial value class already stored in a memory 137 (block ST8c), and determines whether the voltage pulse of the classification is applied once or twice (block ST8d).

Since the count is one in this case, the controller 138 determines that the hub RT1 is an apparatus complying with the conventional IEEE802.3af. Accordingly, the controller 138 reads out, from the memory 137, a class value indicating power class 4 set in accordance with the maximum power consumption of the terminal (block ST8e), and determines whether the class values match (block ST8f). Since the class value differs from the present class value stored in the memory 137 (NO), the controller 138 controls a latching relay 135 to turn off a resistor R4 of a class setting resistor 134, and turn on a resistor R3 (block ST8g). After that, the controller 138 stores a class value corresponding to power class 3 in the memory 137 (block ST8h), turns off a power supply path cut-off switch 132 for a predetermined time, and performs reactivation (block ST8i).

Assume that a hub RT3 installed in private A of the main office has recovered from a failure. Assume also that the user of the IP telephone terminal T11 complying with the IEEE802.3at has removed the IP telephone terminal T11 connected to the hub RT1 installed in private B, and connected the IP telephone terminal T11 to the hub RT3. In this case, the controller 138 detects how many times the voltage pulse of the classification is applied (i.e., detects class events). Since the count is two in this case, the controller 138 determines that the hub RT3 is an apparatus complying with the IEEE802.3at.

Then, the controller 138 reads out, from the memory 137, the class value indicating power class 3 set in accordance with the maximum power consumption of the terminal (block ST8j), and determines whether the class value corresponds to power class 4 (block ST8k).

Since the class value differs from the present class value stored in the memory 137 (NO), the controller 138 controls the latching relay 135 to turn off the resistor R3 of the class setting resistor 134, and turn on the resistor R4 (block ST8l). After that, the controller 138 stores the class value corresponding to power class 4 in the memory 137 (block ST8m), turns off the power supply path cut-off switch 132 for a predetermined time, and performs reactivation (block ST8n).

Note that if the class value stored in the memory 137 matches (YES) in block ST8f described above, the controller 138 immediately terminates the processing. Note also that if the class value stored in the memory 137 matches (YES) in block ST8k described above, the controller 138 immediately terminates the processing.

As described above, the same functions and effects as those of the above-mentioned first embodiment can be obtained in the second embodiment as well.

### Other Embodiments

In each embodiment described above, an example in which only audio communication can be performed by the IEEE802.3af and video communication can be performed by the IEEE802.3at has been explained. However, the each embodiment is not limited to this, and it is also possible to perform, e.g., electronic games by the IEEE802.3at.

In addition, in each embodiment described above, a communication apparatus has been explained by taking an IP telephone terminal as an example. However, a communication apparatus can also be, e.g., a surveillance camera or personal computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication apparatus receiving electric power supplied from a power sourcing equipment, comprising:
a processor configured to operate by a power class selectively set from a plurality of power classes including different maximum power supply amounts in accordance with a connected power sourcing equipment, and executes a communication process;
a detector configured to detect a count of an authentication process executed between the communication apparatus and the power sourcing equipment when the communication apparatus is connected to the power sourcing equipment; and
a controller configured to set in the processor a power class corresponding to the connected power sourcing equipment, based on a detection result obtained by the detector.

2. The apparatus of claim 1, wherein
the processor selectively turns on a plurality of resistors corresponding to the power classes, and
the controller switches a resistor as a change source in an ON state to an OFF state, and switches a resistor as a change destination to the ON state, when changing the power class.

3. The apparatus of claim 1, wherein the controller turns off a switch for performing ON/OFF switching between the power sourcing equipment and the processor for a predetermined period, and turns on the switch after an elapse of the predetermined period, thereby performing reactivation, when changing the power class.

4. The apparatus of claim 1, when changing a connection of the communication apparatus from a first power sourcing equipment connected to the communication apparatus to a second power sourcing equipment corresponding to a power class to which the first power sourcing equipment does not correspond, wherein the controller changes a power class set in the processor and corresponding to the first power sourcing equipment to the power class corresponding to the second power sourcing equipment.

5. The apparatus of claim 1, further comprising an authentication processor configured to execute an authentication process between the communication apparatus and a connected power sourcing equipment,
wherein the authentication processor includes the detector, and
the controller comprehensively controls processes performed by the processor and the authentication processor.

6. A power control method of a communication apparatus receiving electric power supplied from a power sourcing equipment, and including a processor which operates by a power class selectively set from a plurality of power classes having different maximum power supply amounts in accordance with a connected power sourcing equipment, and executes a communication process, comprising:
detecting a count of an authentication process executed between the communication apparatus and the power sourcing equipment when the communication apparatus is connected to the power sourcing equipment; and
setting, in the processor, a power class corresponding to the connected power sourcing equipment, based on a detection result.

7-10. (canceled)

11. A non-transitory computer readable medium having stored thereon a computer program which is executable by a communication apparatus, the computer program controlling the communication apparatus to execute functions of:
a processor configured to operate by a power class selectively set from a plurality of power classes including different maximum power supply amounts in accordance with a connected power sourcing equipment, and executes a communication process;
a detector configured to detect a count of an authentication process executed between the communication apparatus and the power sourcing equipment when the communication apparatus is connected to the power sourcing equipment; and
a controller configured to set in the processor a power class corresponding to the connected power sourcing equipment, based on a detection result obtained by the detector.

12-15. (canceled)
